(19) United States
(12) Patent Application Publication
(10) Pub. No.: US 2021/0409744 A1
(43) Pub. Date: Dec. 30, 2021

(54) IMAGE DECODING DEVICE, IMAGE DECODING METHOD, AND PROGRAM

(71) Applicant: KDDI CORPORATION, Tokyo (JP)

(72) Inventors: Kei KAWAMURA, Fujimino-shi (JP); Sei NAITO, Fujimino-shi (JP)

(73) Assignee: KDDI CORPORATION, Tokyo (JP)

(21) Appl. No.: 17/471,357

(22) Filed: Sep. 10, 2021

Related U.S. Application Data
(63) Continuation of application No. PCT/JP2020/008776, filed on Mar. 2, 2020.

(30) Foreign Application Priority Data
Mar. 12, 2019 (JP) 2019-044644

(51) Int. Cl. H04N 19/44; H04N 19/117; H04N 19/80; H04N 19/176

(52) U.S. Cl. CPC H04N 19/44; H04N 19/176; H04N 19/80; H04N 19/117

(57) ABSTRACT

An image decoding device includes: a boundary strength calculator (that calculates a boundary strength of a block boundary based on input side information; a weight coefficient determinator (108C/108D) that determines a weight coefficient based on the boundary strength; and a difference filter adder that generates a post-filter image based on a difference filter image, a pre-filter image, and the weight coefficient which are input.

### CROSS REFERENCE TO RELATED APPLICATIONS

The present application is a continuation based on PCT Application No. PCT/JP2020/008776, filed on Mar. 2, 2020, which claims the benefit of Japanese patent application No. 2019-044644 filed on Mar. 12, 2019. The entire contents of which are hereby incorporated by reference.

### TECHNICAL FIELD

The present invention relates to an image decoding device, an image decoding method, and a program.

### BACKGROUND

Conventionally, an image encoding method using intra prediction or inter prediction, transform/quantization of a prediction residual signal, and entropy encoding has been proposed (see, for example, ITU-T H.265 High Efficiency Video Coding).

An image encoding device adopting such an image encoding method performs the following processing.
An input image is divided into a plurality of blocks.
A residual signal that is a difference between an intra prediction image or an inter prediction image and the input image is transformed and quantized for each transform unit in the divided block unit (one or a plurality of transform units) to generate a level value.
Entropy encoding is performed on the generated level value together with side information (related information such as a prediction mode and a motion vector necessary for reconstructing the pixel value) to generate encoded data.

On the other hand, an image decoding device adopting an image decoding method corresponding to such an image encoding method obtains an output image from encoded data by a procedure reverse to the procedure performed by the above-described image encoding device.

Specifically, the image decoding device performs the following processing.
The level value obtained from the encoded data is inversely quantized and inversely transformed to generate a residual signal.
Such a residual signal is added to the intra prediction image or the inter prediction image to generate a locally decoded image before filtering.
Using such a locally decoded image before filtering, intra prediction is performed, and at the same time, an in-loop filter (for example, a deblocking filter) is applied to generate a locally decoded image after filtering, and the locally decoded image after filtering is accumulated in a frame buffer.

Here, the frame buffer appropriately supplies the locally decoded image after filtering to the inter prediction.

Processing of obtaining the side information and the level value from the encoded data is called “parsing processing”, and reconstructing the pixel value using the side information and the level value is called “decoding processing”.

Next, an in-loop filter method based on a convolutional neural network (hereinafter, CNN) described in AHG9: Convolutional neural network loop filter, JVET-M0159v1 will be described.

Here, assuming that the color format is 4:2:0, the number of pixels of the luminance image (Luma) and the chrominance image (Chroma) is 4:1:1. Therefore, four luminance pixels and two chrominance pixels are packed to form six channels.

Furthermore, a layer represented by “w×h×c×f” is defined with a width w, a height h, the number c of input channels, and the number f of filters. Specifically, three layers of “L1=3×3×6×8”, “L2=3×3×8×8”, and “L3=3×3×8×6” are introduced.

In the filter processing of the in-loop filter method, as illustrated in FIG. 6, the following processing is performed.

A pre-filter image (the luminance image and the chrominance image) is packed to obtain a pre-filter packing image.

The filter groups L1 to L3 are applied to the pre-filter packing image.

The post-filter image is unpacked to be returned to the luminance image and the chrominance image to obtain a difference filter image.

The pre-filter image and the difference filter image are added.

The filter coefficients of the filters L1 to L3 are determined by learning using an actually encoded image about every one second.

In the filtering processing, the image encoding device determines whether or not the filtering processing is applied for each encoding block, and performs signaling on the image decoding device using a flag. Furthermore, the filter coefficient obtained by learning is quantized and is subjected to signaling as side information from the image encoding device to the image decoding device.

### SUMMARY

However, in the filter processing of the in-loop filter method based on the existing CNN, since the side information such as the prediction mode obtained from the bit stream is not used, there is a problem that the filter processing is excessively applied and the encoding performance is deteriorated.

Therefore, the present invention has been made in view of the above-described problem, and an object of the present invention is to provide an image decoding device, an image decoding method, and a program capable of appropriately correcting a difference filter image obtained by filter processing of an in-loop filter method based on CNN and improving encoding performance.

The first aspect of the present invention is summarized as an image decoding device, including: a boundary strength calculator that calculates a boundary strength of a block boundary based on input side information; a weight coefficient determinator that determines a weight coefficient based on the boundary strength; and a difference filter adder that generates a post-filter image based on a difference filter image, a pre-filter image, and the weight coefficient which are input.

The second aspect of the present invention is summarized as an image decoding method, including: calculating a boundary strength of a block boundary based on input side information; determining a weight coefficient based on the boundary strength; and generating a post-filter image based on a difference filter image, a pre-filter image, and the weight coefficient which are input.

The third aspect of the present invention is summarized as a program configured to cause a computer to function as an image decoding device, the image decoding device including: a boundary strength calculator that calculates a boundary strength of a block boundary based on input side information; a weight coefficient determinator that determines a weight coefficient based on the boundary strength; and a difference filter adder that generates a post-filter image based on a difference filter image, a pre-filter image, and the weight coefficient which are input.

According to the present invention, it is possible to provide an image decoding device, an image decoding method, and a program capable of appropriately correcting a difference filter image obtained by filter processing of an in-loop filter method based on CNN and improving encoding performance.

### BRIEF DESCRIPTION OF DRAWINGS

FIG. 1 is a diagram illustrating an example of a configuration of an image processing system 1 according to an embodiment.

FIG. 2 is a diagram illustrating an example of functional blocks of an image encoding device 100 according to the embodiment.

FIG. 3 is a diagram illustrating an example of functional blocks of an in-loop filter unit 108 of the image encoding device 100 and an in-loop filter unit 206 of an image decoding device 200 according to the embodiment.

FIG. 4 is a diagram illustrating an example of functional blocks of the image decoding device 200 according to the embodiment.

FIG. 5 is a flowchart illustrating an example of operation of the in-loop filter unit 108 of the image encoding device 100 and the in-loop filter unit 206 of the image decoding device 200 according to the embodiment.

FIG. 6 is a diagram for describing a conventional technique.

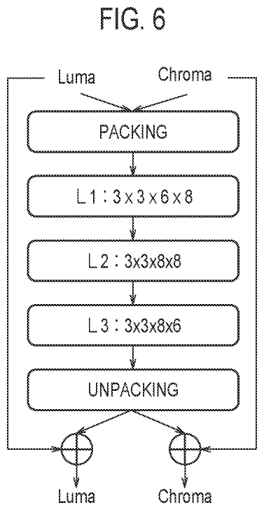

### DETAILED DESCRIPTION

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

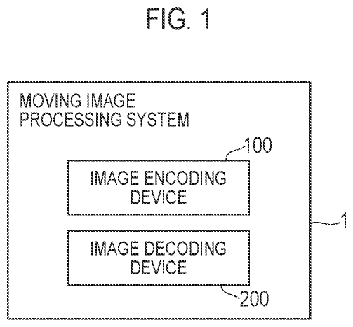

FIG. 1 is a diagram illustrating an example of functional blocks of an image processing system 1 according to a first embodiment of the present invention. The image processing system 1 includes an image encoding device 100 that encodes a moving image to generate encoded data, and an image decoding device 200 that decodes the encoded data generated by the image encoding device 100. The above-described encoded data is transmitted and received between the image encoding device 100 and the image decoding device 200 via a transmission path, for example.

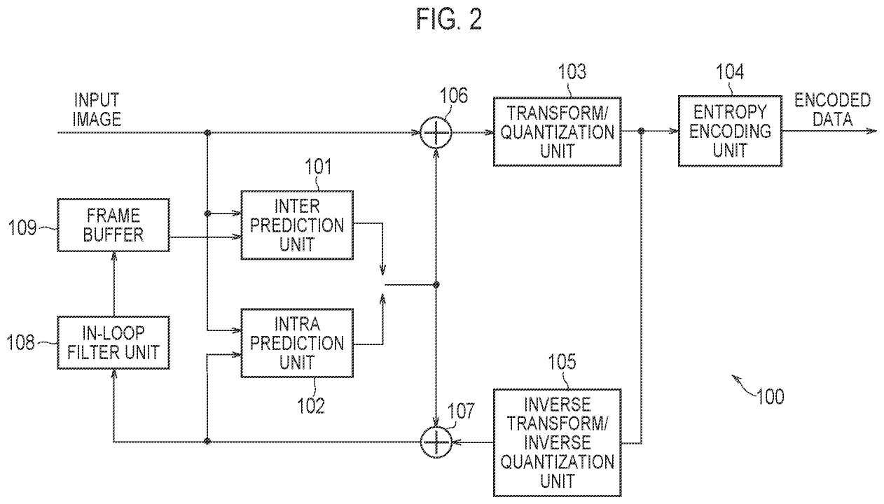

FIG. 2 is a diagram illustrating an example of function blocks of the image encoding device 100 according to the present embodiment. As illustrated in FIG. 2, the image encoding device 100 includes an inter prediction unit 101; an intra prediction unit 102; a transform/quantization unit 103; an entropy encoding unit 104; an inverse transform/inverse quantization unit 105; a subtraction unit 106; an addition unit 107; an in-loop filter unit 108; and a frame buffer 109.

The inter prediction unit 101 is configured to perform inter prediction using an input image and a locally decoded image after filtering (described later) input from the frame buffer 109 to generate and output an inter prediction image.

The intra prediction unit 102 is configured to perform intra prediction using an input image and a locally decoded image before filtering (described later) to generate and output an intra prediction image.

The transform/quantization unit 103 is configured to perform orthogonal transform processing on the residual signal input from the subtraction unit 106, perform quantization processing on a transform coefficient obtained by the orthogonal transform processing, and output a quantized level value obtained by the quantization processing.

The entropy encoding unit 104 is configured to perform entropy encoding on the quantized level value and the side information input from the transform/quantization unit 103 and output the encoded data.

The inverse transform/inverse quantization unit 105 is configured to perform inverse quantization processing on the quantized level value input from the transform/quantization unit 103, perform inverse orthogonal transform processing on the transform coefficient obtained by the inverse quantization processing, and output an inversely orthogonally transformed residual signal obtained by the inverse orthogonal transform processing.

The subtraction unit 106 is configured to output a residual signal that is a difference between the input image and the intra prediction image or the inter prediction image.

The addition unit 107 is configured to output the locally decoded image before filtering obtained by adding the inversely orthogonally transformed residual signal input from the inverse transform/inverse quantization unit 105 and the intra prediction image or the inter prediction image.

The in-loop filter unit 108 is configured to apply in-loop filter processing such as deblocking filter processing to the locally decoded image before filtering input from the addition unit 107 to generate and output the locally decoded image after filtering.

The frame buffer 109 accumulates the locally decoded image after filtering and appropriately supplies the locally decoded image after filtering to the inter prediction unit 101 as the locally decoded image after filtering.

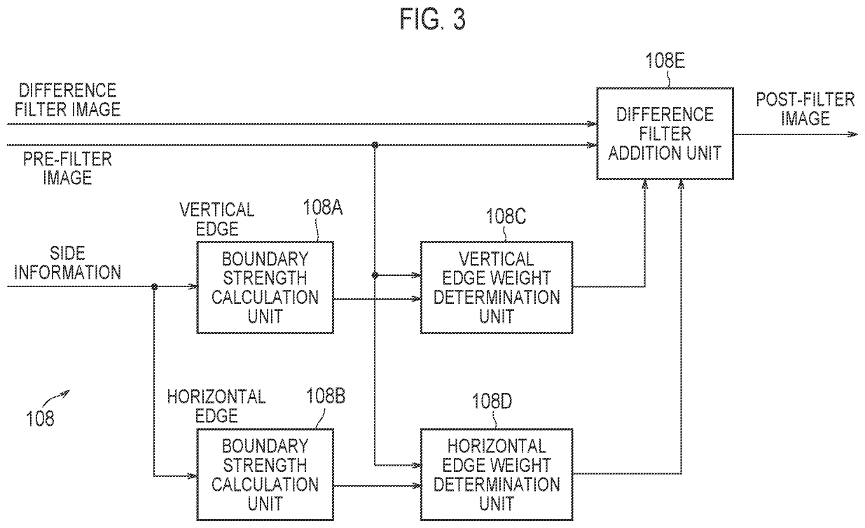

Hereinafter, the in-loop filter unit 108 of the image encoding device 100 according to the present embodiment will be described with reference to FIG. 3. FIG. 3 is a diagram illustrating an example of functional blocks of the in-loop filter unit 108 of the image encoding device 100 according to the present embodiment.

As illustrated in FIG. 3, the in-loop filter unit 108 of the image encoding device 100 according to the present embodiment includes a boundary strength calculation unit (boundary strength calculator) 108A, a boundary strength calculation unit (boundary strength calculator) 108B, a vertical weight determination unit (weight coefficient determinator) 108C, a horizontal weight determination unit (weight coefficient determinator) 108D, and a difference filter addition unit (difference filter adder) 108E.

Furthermore, filtering processing using an optional filter such as a deblocking filter, an adaptive loop filter, or a sample adaptive offset filter may be performed before the input of the in-loop filter unit 108 or after the output of the in-loop filter unit 108.

That is, a pre-filter image that is an input of the in-loop filter unit 108 is a post-filter image obtained by filtering processing using another filter.

A difference filter image that is an input of the in-loop filter unit 108 is an image obtained by applying a model based on a difference network configuration based on CNN to the pre-filter image. Such a model is optional. However, such a model is a model intended to improve subjective image quality at a block boundary.

The boundary strength calculation unit 108A/108B is configured to calculate and output the boundary strength based on the input side information.

Here, the boundary strength calculation unit 108A/108B may be configured to calculate the boundary strength so as to be the same as the boundary strength in the filtering processing using the existing deblocking filter.

Such side information includes a prediction mode type for identifying an intra prediction mode, an inter prediction mode, or the like, a flag indicating whether or not a non-zero coefficient exists in a block, a motion vector, and a reference image number.

Furthermore, the boundary strength indicates whether or not a subjectively conspicuous block boundary (edge) is likely to occur by the encoding processing, and is represented by three stages of “0”, “1”, and “2”. Here, “0” indicates that there is no block boundary, “1” indicates that there is a weak block boundary, and “2” indicates that there is a strong block boundary.

For example, the boundary strength calculation unit 108A/108B may be configured to set the boundary strength to “2” if the intra prediction mode is applied to at least one of the two blocks sandwiching the block boundary.

In addition, the boundary strength calculation unit 108A/108B may be configured to set the boundary strength to “1” when a flag indicating whether a non-zero coefficient exists in at least one of the two blocks sandwiching the block boundary is valid, and the block boundary is a boundary of the conversion block.

Further, the boundary strength calculation unit 108A/108B may be configured to set the boundary strength to “1” when the absolute value of the difference between the motion vectors of the two blocks sandwiching the block boundary is 1 pixel or more.

Further, the boundary strength calculation unit 108A/108B may be configured to set the boundary strength to “1” when the reference image numbers for motion compensation of the two blocks sandwiching the block boundary are different.

Further, the boundary strength calculation unit 108A/108B may be configured to set the boundary strength to “1” when the number of motion vectors for motion compensation of the two blocks sandwiching the block boundary are different.

The boundary strength calculation unit 108A/108B may be configured to set the boundary strength to “0” other than the above cases.

Here, the boundary strength calculation unit 108A is configured to calculate a boundary strength related to a block boundary extending in the vertical direction, and the boundary strength calculation unit 108B is configured to calculate a boundary strength related to a block boundary extending in the horizontal direction.

The vertical edge weight determination unit 108C and the horizontal edge weight determination unit 108D are examples of weight determination units configured to determine a weight coefficient used when adding the difference filter image and the pre-filter image based on the boundary strengths input from the boundary strength calculation units 108A/108B, respectively.

For example, when the boundary strength is “2”, the vertical edge weight determination unit 108C and the horizontal edge weight determination unit 108D may be configured to determine the weight coefficients such as “4/4”, “3/4”, “2/4”, and “1/4” for each of four pixels from the block boundary and for each of four pixels from the position close to the block boundary.

Similarly, when the boundary strength is “1”, the vertical edge weight determination unit 108C and the horizontal edge weight determination unit 108D may be configured to determine the weight coefficients such as “4/8”, “3/8”, “2/8”, and “1/8” for each of four pixels from the block boundary and for each of four pixels from the position close to the block boundary.

The vertical edge weight determination unit 108C is configured to determine a weight coefficient related to a block boundary extending in the vertical direction, and the horizontal edge weight determination unit 108D is configured to determine a weight coefficient related to a block boundary extending in the horizontal direction.

The difference filter addition unit 108E is configured to generate and output a post-filter image based on the input pre-filter image, difference filter image, and weight coefficient.

Specifically, the difference filter addition unit 108E is configured to generate the post-filter image by multiplying the difference filter image by the weight coefficient and then adding the resultant image to the pre-filter image.

In the present embodiment, the boundary strength calculation unit 108A and the boundary strength calculation unit 108B are separately provided, and the vertical edge weight determination unit 108C and the horizontal edge weight determination unit 108D are separately provided. However, the present invention is not limited to such a case, and a boundary strength calculation unit 108AB (not illustrated) may be provided instead of the boundary strength calculation unit 108A and the boundary strength calculation unit 108B, and a weight determination unit 108CD (not illustrated) may be provided instead of the vertical edge weight determination unit 108C and the horizontal edge weight determination unit 108D.

In such a case, the boundary strength calculation unit 108AB is configured to calculate a boundary strength of a block boundary regardless of the vertical direction and the horizontal direction, and the weight determination unit 108CD is configured to determine a weight coefficient related to a block boundary regardless of the vertical direction and the horizontal direction.

Although the weight determination unit 108CD and the difference addition unit 108E are separately provided in the present embodiment, the present invention is not limited to such a case, and a boundary detection unit 108F (not illustrated) may be provided instead of the boundary strength calculation unit 108AB, and a filter correction unit 108G (not illustrated) may be provided instead of the weight determination unit 108CD and the difference addition unit 108E.

In such a case, the boundary detection unit 108F is configured to detect (determine) a block boundary area (edge area) regardless of the boundary strength of the block boundary, and the filter correction unit 108G is configured to correct the pre-filter image by the difference filter image related to the block boundary area regardless of the weight coefficient related to the block boundary.

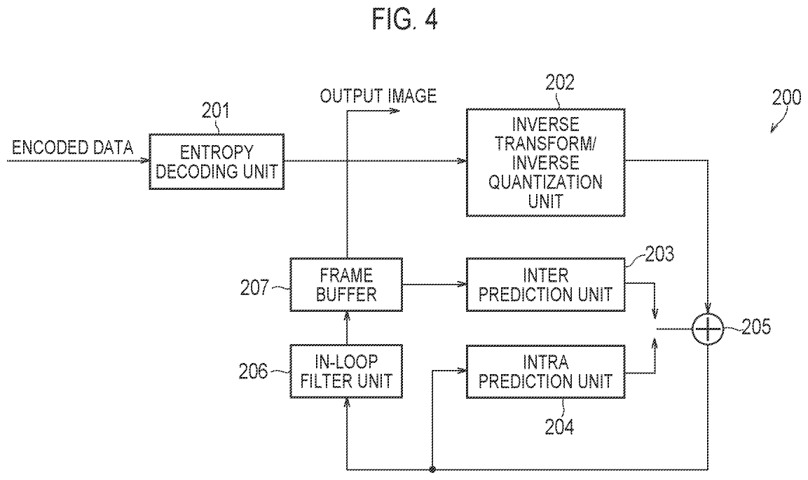

FIG. 4 is a block diagram of the image decoding device 200 according to the present embodiment. As illustrated in FIG. 3, the image decoding device 200 according to the present embodiment includes an entropy decoding unit 201, an inverse transform/inverse quantization unit 202, an inter prediction unit 203, an intra prediction unit 204, an addition unit 205, an in-loop filter unit 206, and a frame buffer 207.

The entropy decoding unit 201 is configured to perform entropy decoding on the encoded data and output a quantized level value and side information.

The inverse transform/inverse quantization unit 202 is configured to perform inverse quantization processing on the quantized level value input from the entropy decoding unit 201, perform inverse orthogonal transform processing on a result obtained by the inverse quantization processing, and output the result as a residual signal.

The inter prediction unit 203 is configured to perform inter prediction using a locally decoded image after filtering input from the frame buffer 207 to generate and output an inter prediction image.

The intra prediction unit 204 is configured to perform intra prediction using a locally decoded image before filtering input from the addition unit 205 to generate and output an intra prediction image.

The addition unit 205 is configured to output the locally decoded image before filtering obtained by adding the residual signal input from the inverse transform/inverse quantization unit 202 and the prediction image (the inter prediction image input from the inter prediction unit 203 or the intra prediction image input from the intra prediction unit 204).

Here, the prediction image is a prediction image calculated by a prediction method expected to have the highest encoding performance obtained by entropy decoding, of the inter prediction image input from the inter prediction unit 203 and the intra prediction image input from the intra prediction unit 204.

The in-loop filter unit 206 is configured to apply in-loop filter processing such as deblocking filter processing to the locally decoded image before filtering input from the addition unit 205 to generate and output the locally decoded image after filtering.

The frame buffer 207 is configured to accumulate the locally decoded image after filtering input from the in-loop filter unit 206, appropriately supply the locally decoded image after filtering to the inter prediction unit 203 as the locally decoded image after filtering, and output the image as a decoded image.

As illustrated in FIG. 3, the in-loop filter unit 206 of the image decoding device 200 according to the present embodiment includes a boundary strength calculation unit 108A, a boundary strength calculation unit 108B, a vertical weight determination unit 108C, a horizontal weight determination unit 108D, and a difference filter addition unit 108E. Here, since each function of the in-loop filter unit 206 is the same as each function of the in-loop filter unit 108 described above, the description thereof will be omitted.

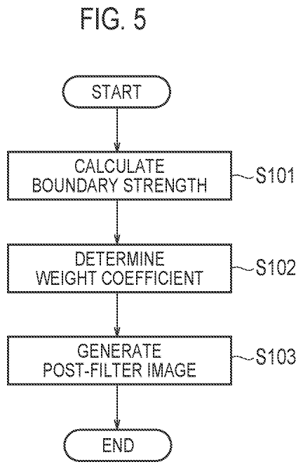

Hereinafter, an example of the operation of the in-loop filter unit 108/206 according to the present embodiment will be described with reference to FIG. 5.

As illustrated in FIG. 5, in step S101, the in-loop filter unit 108/206 calculates the above-described boundary strength based on the input side information.

In step S102, the in-loop filter unit 108/206 determines the above-described weight coefficient based on the calculated boundary strength and the pre-filter image.

In step S103, the in-loop filter unit 108/206 generates a filter image based on the input difference filter image, pre-filter image, and weight coefficient.

According to the image processing system 1 of the present embodiment, a difference filter image obtained by filter processing of an in-loop filter method based on the CNN can be appropriately corrected, and the encoding performance can be improved.

Hereinafter, an image processing system 1 according to a second embodiment of the present invention will be described focusing on differences from the image processing system 1 according to the first embodiment described above.

In the present embodiment, the vertical edge weight determination unit 108C and the horizontal edge weight determination unit 108D of the in-loop filter unit 108/206 are configured to output the above-described weight coefficient based on the input boundary strength and prediction mode.

For example, when the boundary strength is “1” or more, the vertical edge weight determination unit 108C and the horizontal edge weight determination unit 108D may be configured to determine the weight coefficients as “4/4”, “3/4”, “2/4”, and “1/4” in order from the position close to the block boundary for the blocks to which intra prediction is applied, and determine the weight coefficients as “4/8”, “3/8”, “2/8”, and “1/8” in order from the position close to the block boundary for the blocks to which inter prediction is applied.

Hereinafter, an image processing system 1 according to a third embodiment of the present invention will be described focusing on differences from the image processing system 1 according to the first embodiment described above.

In the present embodiment, the difference filter addition unit 108E of the in-loop filter unit 108/206 is configured to generate and output the above-described post-filter image based on the input pre-filter image, difference filter image, weight coefficient, and quantization parameter.

Specifically, the difference filter addition unit 108E is configured to determine a weight coefficient according to the quantization parameter of the current block based on the quantization parameter used for learning, multiply the input difference filter image by the weight coefficient determined by the quantization parameter, multiply the resultant image by the input weight coefficient, and add the resultant image to the pre-filter image to generate the post-filter image.

For example, when the model is learned with the quantization parameter QP=32, the difference filter addition unit 108E may be configured to determine the weight coefficient as “12/64” if “QP=22” and determine the non-negative weight coefficient proportional to the quantization parameter as “90/64” if “QP=37” in the current block.

What is claimed is:

1. An image decoding device, comprising:
a boundary strength calculator that calculates a boundary strength of a block boundary based on input side information;
a weight coefficient determinator that determines a weight coefficient based on the boundary strength; and
a difference filter adder that generates a post-filter image based on a difference filter image, a pre-filter image, and the weight coefficient which are input.

2. The image decoding device according to claim 1, wherein
the boundary strength calculator determines, as the boundary strength, each of a boundary strength of a block boundary extending in a vertical direction and a boundary strength of the block boundary extending in a horizontal direction.

3. The image decoding device according to claim 1, wherein
the weight coefficient determinator determines the weight coefficient based on the boundary strength and a prediction mode.

4. The image decoding device according to claim 1, wherein
the difference filter adder generates the post-filter image based on the difference filter image, the pre-filter image, the weight coefficient, and a quantization parameter.

5. An image decoding method, comprising:
calculating a boundary strength of a block boundary based on input side information;
determining a weight coefficient based on the boundary strength; and
generating a post-filter image based on a difference filter image, a pre-filter image, and the weight coefficient which are input.

6. A program configured to cause a computer to function as an image decoding device,
the image decoding device comprising:
a boundary strength calculator that calculates a boundary strength of a block boundary based on input side information;
a weight coefficient determinator that determines a weight coefficient based on the boundary strength; and
a difference filter adder that generates a post-filter image based on a difference filter image, a pre-filter image, and the weight coefficient which are input.
